(19) United States
(12) Patent Application Publication
(10) Pub. No.: US 2002/0021216 A1
(43) Pub. Date: Feb. 21, 2002

(54) Configuration for generating a response signal, carrying an information item, to a received electromagnetic radiation, and method for generating the response signal

(76) Inventors: Martin Vossiek, Munchen (DE); Frank Schmidt, Poring (DE); Andre Albsmeier, Munchen (DE); Ulrich Knauer, Munchen (DE); Oliver Sczesny, Aschheim (DE)

Correspondence Address: LERNER AND GREENBERG, P.A., Post Office Box 2480, Hollywood, FL, 33022-2480, US

(21) Appl. No.: 09/910,751

(22) Filed: Jul. 23, 2001

Related U.S. Application Data
(63) Continuation of application No. PCT/DE00/00128, filed on Jan. 14, 2000.

(30) Foreign Application Priority Data
Jan. 21, 1999 (DE) 199 02 261.5

(51) Int. Cl. G08B 13/18

(52) U.S. Cl. 340/567; 340/540

(57) ABSTRACT

In a configuration, a received radiation is converted into a storable secondary energy by a transducer. From the stored secondary energy, a nonlinear element of the configuration generates a radio-frequency signal. A coding element impresses an information item on the radio-frequency signal to generate a response signal. The impressed information can be information on the value of an environmental parameter detected by the coding element, which, in turn, can be a physical quantity or type and/or concentration of a substance.

### CROSS-REFERENCE TO RELATED APPLICATION

This application is a continuation of copending International Application No. PCT/DE00/00128, filed Jan. 14, 2000, which designated the United States.

### BACKGROUND OF THE INVENTION

### Field of the Invention

The invention relates to a configuration for generating a response signal, carrying an information item, to a received electromagnetic radiation, and a method for generating the response signal.

Such a configuration and such a method are known from each of the following documents:

[1] European patent EP 0619906 B1

[2] European patent EP 0746775 B1

[3] German patent DE 4413211 C2

[4] European patent application EP 0 773 451 A1

[5] B. Breuer, R. Isermann, Colloquium on contactless transmission of measurement data and power, progress reports VDI Series 8 No. 515, VDI-Verlag, 1995

[6] International patent application WO98/36395 A2

The configuration also may be called a “transponder system”.

Configurations and methods of this type have a very great potential for applications, especially as identification or sensor systems that operate contactlessly.

The relevant passage in document [5] by Breuer et al. discusses the paper “Funksensorik mit passiven Oberflächenwellen-Komponenten (OFW)” [Radio sensors with passive surface acoustic wave components (SAW)] by L. Reindl and V. Mágori, pp. 62 to 79. This paper provides basic information on designing a transponder system with a surface acoustic wave element. In addition, reference is made to the paper “Sensorreifen mit berührungsloser Daten-und Energieübertragung” [Sensor tires with contactless data and power transmission] by J. Stöcker, P. Hahne and B. Breuer, pp. 10 to 23, and the paper “Ferngespeiste injizierbare Transponder zur Erfassung von physiologischen Daten” [Remotely fed injectable transponders for acquiring physiological data] by I. Wolff and N. H. L. Koster, pp. 80-91. Each of these two papers mentioned describes a transponder system, which, however, does not operate with a surface acoustic wave element, and is of interest with regard to the technological background that is significant here.

For many applications, a system is of interest in which a coding element that has the identification or sensor function operates without its own power supply such as battery and in which the response signal is generated from the energy of an interrogation signal. In a known transponder system, a voltage is generated from the transmitted electromagnetic energy. This voltage operates an active electronic circuit configuration that contains the coding element, uses the latter to regenerate the desired information, and sends it to the interrogating device. Because the minimum voltage above which such an electronic circuit (e.g. CMOS) can operate is relatively high, the range of this transponder system is relatively short.

A transponder system containing a SAW element as coding element can operate purely passively. In the SAW element, the high-frequency electrical interrogating signal is converted into a surface acoustic wave. Structures applied to the surface modify the surface acoustic wave and possibly as do environmental conditions and then convert it back into an electrical signal. The modification of the surface acoustic wave is impressed on this electrical signal so that, with known geometric arrangement of the structures, a conclusion can be drawn regarding the magnitude of the modification. A capability for reading the SAW element by radio is achieved by connecting the SAW element to an antenna. The element is then interrogated or “read” from some distance by an interrogating device in accordance with the principle of radar.

The disadvantages in the known transponder systems and methods is that the transmission of the energy from the interrogating device to the coding element is in each case only possible with poor efficiency so that the spatial range is restricted, and/or high transmitting power must be used. The latter leads to a high burden on the environment due to the relatively high-energy consumption and the problems with electromagnetic compatibility. Although a directional antenna can optimize the power transmission, it severely restricts the possible field of use or working area (interrogating location) of the configuration relative to the interrogating device.

A further disadvantage is that in the case where a number of configurations are located within the working area of an interrogating device, all configurations respond simultaneously to an interrogating signal. It is therefore possible to implement a group-handling capability only in a restricted way. Group-handling capability is when a number of configurations can be located within the working area of an interrogating device and the response signals do not significantly interfere with one another so that unambiguous identification and interrogation of each individual configuration is possible.

A further restriction is produced by the fact that the interrogating signal is modified directly on the SAW element and the characteristics of the interrogating signal (center frequency and bandwidth) must, therefore, be tailored for the SAW element. In general, therefore, the interrogating signal cannot be configured with the maximum possible energy transmission in mind.

A known embodiment of a radio-scannable transponder system containing a SAW sensor as coding element is obtained if the coding element is not excited by a transmitted interrogating signal but by a high-frequency signal that is generated from process energy. In this case, the transmitting unit in the interrogating device can be omitted. A configuration for generating a coded high-frequency signal from process energy is shown in [6]. In this configuration, a transducer is used for converting thermal, mechanical or electromagnetic process energy into electrical energy. Since the transmitting event takes place in dependence on the energy state at the location of the coding element and thus rather randomly and, in addition, the transmitted pulses are very short, a group-handling capability with a very wide range is obtained. The disadvantageous factor is that the configuration cannot be selectively interrogated, but operates independently. This greatly restricts any selective diagnostics, e.g. whether the configuration is still operating, and its use in a safety-related area.

It is, therefore, an object of the present invention to specify a configuration and a method by which the contactless selective interrogation of information without power source in the configuration can be performed in a better way than previously. In particular, the invention is intended to specify a configuration with group-handling capability.

### SUMMARY OF THE INVENTION

It is accordingly an object of the invention to provide a configuration for generating a response signal, carrying an information item, to a received electromagnetic radiation, and method for generating the response signal that overcomes the hereinafore-mentioned disadvantages of the heretofore-known devices of this general type.

With the foregoing and other objects in view, there is provided, in accordance with the invention, a configuration for generating an information-bearing response signal to a received electromagnetic radiation. The configuration includes a receiver, a transducer, a storage device, a nonlinear element, a coding element, and a transmitting antenna. The receiver receives electromagnetic radiation. The transducer couples to the receiver and changes the radiation into a storable secondary energy. The storage device connects to the transducer and stores the storable secondary energy. The nonlinear element connects to the storage device and generates a pulse-shaped radio-frequency signal from the storable secondary energy when a threshold value is reached in the storage device. The coding element connects to the nonlinear element and impresses information on the radio-frequency signal to generate a response signal. A transmitting antenna connects to the coding element and broadcasts the response signal.

With the objects of the invention in view, there is also provided a method for remotely interrogating a configuration for generating an information-bearing response signal to a received electromagnetic radiation. The first step in the sequence is to provide a configuration. The next step is to generate an electromagnetic radiation of relatively low amplitude in an interrogating device. The next step is to transmit the radiation to the configuration. The next step is to store secondary energy of the radiation in the configuration. The next step is to generate a short pulse-shaped radio-frequency signal of relatively high amplitude from the stored secondary energy when a threshold value is reached. The next step is to impress an information item on the short radio-frequency signal to generate a response signal. The next step is to radiate the response signal.

The basic concept includes converting a radiation at the location of a coding element, using a transducer, into a secondary form of energy that is temporarily stored. This stored secondary energy is then supplied to a nonlinear element that generates from it a high-frequency signal that, in turn, is conducted to the coding element where information is impressed on it and thus a response signal is generated. This information can be an information item on the identity of the coding element or of the configuration or an information item on the value of an environmental parameter detected by the coding element configured as a sensor, which, in turn, can be a physical quantity or type and/or concentration of a substance. The configuration is configured in such a manner that the nonlinear element only responds when a certain limit value with respect to the stored secondary energy is reached.

This ensures a delay of the response signal compared with the original radiation that can be an interrogating signal.

The primary energy used for an interrogating signal is an electromagnetic radiation of any wavelength for which a corresponding receiver is provided in the configuration. In particular, radio-frequency radiation in the radio or microwave range and light and especially laser light are possible. In a suitable receiver, the electromagnetic radiation can also have any bandwidth and still can be completely used. This ensures a high efficiency in the utilization of the radiation.

The receiver used can be, in particular, an antenna, a photoelectric cell, or a photovoltaic cell.

A preferred secondary energy is heat energy. This has the advantage that, in principle, all media having mass are suitable as temporary storage for this. However, other forms of energy, e.g. mechanical pressure energy or electrical charge, are also conceivable.

The transducer used for changing the radiation energy into heat energy can be a radio-frequency heater or any other heating element depending on whether electrical energy is generated on an intermediate basis in the receiver such as, for example, in the case of a photovoltaic cell.

If electrical energy is generated in the receiver, it can be stored directly in the form of a charge in a capacitor. It is also possible to use the electrical energy to charge up an accumulator or another electrochemical storage element.

In the case of a non-electrical secondary energy and, in particular, in the case of heat energy, the intermediate storagee is connected to a further transducer that converts the stored form of secondary energy into electrical energy. This further transducer can be a thermocouple or a pyroelectrical element that generates an electrical charge from the intermediate energy. When the form of secondary energy is pressure, a piezoelectric element is highly suitable as the further transducer.

A nonlinear element that changes the stored secondary energy into a pulse-shaped radio-frequency signal is coupled to this temporary storage device or the further transducer. If the stored secondary energy exceeds a particular level, it is discharged within a very short time with the aid of the nonlinear element and, in this manner, a short electrical pulse is generated which has a very high amplitude compared with the received primary signal (radiation).

The following are particularly suitable as a nonlinear element: a spark gap, a diode, a gas discharge tube or an avalanche semiconductor element.

In the coding element, the aforementioned information is impressed on the pulse-shaped radio-frequency signal and a response signal is generated. It is possible to impress both identity-related information and sensor information. As a result, the response signal that is transmitted rather randomly with respect to time can be allocated to a particular coding element.

A SAW component is a preferred embodiment for the coding element. It can be used both as ID marker or ID TAG and as sensor because of its sensitivity to a force or temperature acting on it.

In addition, a resonator configuration, a delay line, a dielectric filter, a coaxial ceramic filter, a volume transducer or an LC filter is suitable for the coding element.

The configuration is suitable for generating from radiation acting on it over a prolonged time (which can also be an active signal, called pumping signal in the text which follows) with comparatively low amplitude, a pulse-shaped signal. This pulse-shaped signal is very short in time and has comparatively high amplitude. The pumping signal used can be not only a microwave signal but also another radiation signal such as a light signal emitted by a laser.

In the text that follows, exemplary embodiments of the invention will be explained with reference to the drawing.

Other features which are considered as characteristic for the invention are set forth in the appended claims.

Although the invention is illustrated and described herein as embodied in a configuration for generating a response signal, carrying an information item, to a received electromagnetic radiation, and method for the generation of the response signal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic and block circuit diagram showing the configuration according to the invention; and

FIG. 2 is a schematic showing an embodiment of the configuration shown in FIG. 1, with a SAW element shown in detail acting as the coding element.

### DESCRIPTION OF THE PREFERRED EMBODIMENTS

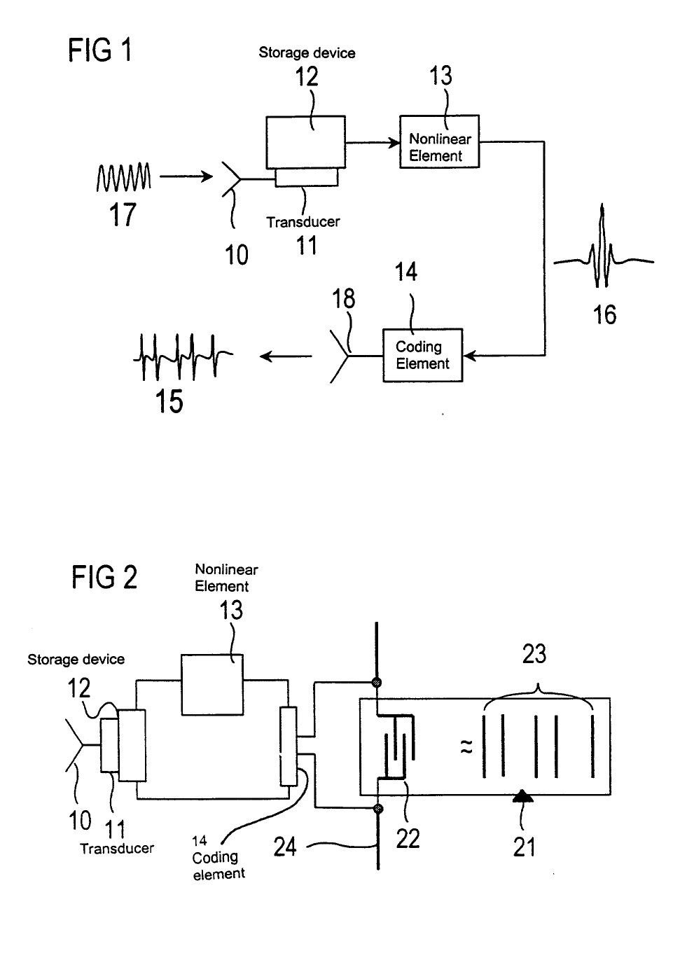

Referring now to the figures of the drawings in detail and first, particularly to FIG. 1 thereof, there is shown a first exemplary embodiment. An RF interrogating signal represents the radiation 17 that is received by an antenna acting as the receiver 10 in the configuration. Using a suitable transducer 11, e.g. a resistance heating element, the received radiation 17 is changed into the secondary energy, in this case heat energy. The storage device 12 used for the heat energy is the mass of an element, preferably a pyroelectrical transducer. The storage device 12 in the form of a pyroelectrical transducer also generates a pyroelectrical voltage that is present across the nonlinear element 13, in this case a spark gap. When a pyroelectrical voltage dependent on the quantity of heat or on the temperature in the storage device 12 (i.e., the pyroelectrical transducer) reaches a threshold value, an electrical flashover occurs in the spark gap 13 and a radio-frequency pulse 16 is generated.

This pulse 16 is supplied to the coding element 14. The coding element 14 provides the pulse 16 with identity-related information and/or sensor information. For this purpose, a multiplicity of elements can be considered. It can be, for example, a SAW element in the form of a resonator configuration, a delay line, a dielectric filter, a mechanical filter, a coaxial ceramic filter, a volume transducer or an LC filter.

In the present case, the configuration generates short response signals in a contactless operating identification system or sensor system. In this configuration, it is possible to selectively request a response of the coding element 14 by sending a pumping signal until the response signal is generated. Because the time duration of the charging process until the activation of the nonlinear element 13 depends on the property of the transmission link and the physical conditions of the storage device 12 and of the transducer 11, etc., the response signal is generated at a quasi-random time that cannot be precisely predicted. If the physical boundary conditions are known (e.g. maximum path loss in the defined area of acquisition, energy and circuit characteristic of the configuration, etc.), a time can be specified after which the configuration must transmit at the latest with a given pump signal as long as it is intact. Thus, selective diagnostics are possible. Due to the quasi-random response time, the configuration can be used for implementing a group-handling capability, unlike the known radio-scannable transponder systems, and it is possible to interrogate a multiplicity of different configurations with a single interrogating device. In addition, the pumping signal can be dimensioned separately from any information-bearing response signal and each response signal can be adapted to its respective function.

Because no active electronic circuit in the conventional sense is operated in the configuration described, the operating principle can also be implemented with a relatively low pumping signal power or, respectively, a wide range can be achieved with moderate antenna dimensions with the same pumping power as with a conventional transponder system.

FIG. 2 shows another exemplary embodiment of a configuration comprising a SAW element 21 as coding element 14. The radio-frequency signal (radiation) transmitted is received by a suitable interrogating device (not shown) using the antenna 10 as receiver. The received energy is used for heating a storage device 12 such as a pyroelectrical transducer or a crystal via a transducer 11 that is preferably a heater. Due to the heating, an electrical voltage is built up across the storage device 12 (i.e., the pyroelectrical transducer) in accordance with the secondary energy stored in the crystal that, when it exceeds a threshold value, causes a nonlinear element 13 (e.g. a spark gap) to break down. During this process, the stored secondary energy discharges like a pulse and generates a pulse-shaped radio-frequency signal. This radio-frequency signal is applied to the interdigital transducer 22 of the SAW element 21 via a suitable adapting circuit (e.g. an adaptive filter or a resonant circuit), and converted into an acoustic signal. This acoustic signal is reflected at the structures 23 located on the SAW element 21 and, after reconversion into an electrical signal, is radiated via the antenna 24 as response signal. The response signal thus coded can then be detected by a suitable receiving unit (not shown) and evaluated. The pulse pattern contains the information on the coding implemented by the structures and/or allows the type or the value of the environmental parameter to be determined from the action of an environmental parameter on the SAW component 21 in the form of a corresponding change in the information.

The storage device 12 (e.g. pyroelectrical transducer, crystal) is thermally insulated from the environment in such a manner that the heating by the received energy is much quicker than the removal of the heat to the environment. At the same time, however, the removal of the heat to the environment is so great that the storage device 12 cools during each transmission interval in which no energy is received, to such an extent that it will not heat beyond a critical point (e.g. Curie temperature) during a defined interrogation/interval ratio even with repeated interrogation.

If separate matching of the antennas 10 and 24 to the interrogation or response signal 17, 18 is not necessary, they can also be constructed as a common single antenna.

In the text that follows, an energy balance of an embodiment according to FIG. 2 is configured. Preferably, the storage device is a pyroelectrical transducer. The material selected for the pyroelectrical transducer is lithium tantalite, which is distinguished by a very high pyroelectrical effect. A mass of one-tenth of a gram (0.1 g) is sufficient for providing the energy for in each case one transmitting process (breakdown of the spark gap 13) with short range (some meters) with a temperature increase of one-half Kelvin (0.5 K).

The specific heat capacity of lithium tantalate is about 0.4 Ws/g*K. Accordingly, to heat a quantity of 0.1 g by 0.5 K, the quantity of energy of 0.4 Ws/g*K*0.5 K*0.1 g=0.02 Ws is required.

During the excitation by a radio signal, the losses produced must also be taken into consideration. In general, the following holds true for the energy balance of a radio transmission:

Pe=(Ps*Ge*Gs*λ²)/4*π*r²

where the symbols stand for the following quantities:

Pe=power absorbed by the receiving antenna;

Ps=transmitting power of the radio-frequency excitation oscillation;

λ=wavelength of the oscillation;

Gs=antenna gain of the transmitting antenna;

Ge=antenna gain of the receiving antenna; and

r=distance between the antennas.

Using the following values as a basis for the exemplary embodiment:

Ps=0.1 W

λ=3 m (100 MHz)

Gs=1

Ge=0.3

r=1 m

produces a received power of Pe=0.02 W. This means that, after a time of 1 s, the quantity of energy of 0.02 Ws has accumulated, which is the quantity required for sending out a response signal. In this calculation, the heat losses and other losses were ignored because they only play a subordinate role in the practical implementation and do not, therefore, significantly change the result of the observation.

The configuration can be very advantageously used for scanning the content of a shopping basket. Each item of goods in the shopping basket (shopping basket, e.g. a shopping trolley, a pallet, a container, a transport vehicle, a conveyor belt or the like) is provided with a configuration as described as the identification element. The shopping basket is irradiated with the pumping signal for the scanning. With each identification mark, the pumping signal then in each case causes a breakdown at quasi-random times, which generates a coded response signal. The duration of the irradiation is selected to be of such a length that it is ensured that each identification mark has transmitted at least once. These transmitted response signals are then received by an interrogating device, not explained in greater detail here. Conclusions regarding the content of the shopping basket are then drawn by evaluating the transmitted coded signals. If an identification mark additionally has a sensor function, the state of an item of goods (e.g. temperature) can also be interrogated.

Another field of application is the application of the configuration as replacement for various authorization mechanisms, for example for computer access control or for licensing the use of software. It can, therefore, be used as replacement for passwords and hardware keys/dongles. In this configuration, each authorized user carries with him an identification mark containing the configuration. The interrogating system that is installed, for example, as plug-in card in the computer (or in the front end of the monitor) sends out a pumping signal at suitable time intervals and finds out whether an identification mark is responding (that is to say, whether a user or a number of users are present).

At present, methods that are based on the use of encrypted passwords are used almost exclusively for controlling computer access. These methods have a number of disadvantages:

a) users choose passwords which are too simple,

b) users forget their passwords,

c) if passwords become known to unauthorized persons, they can be used by them without the loss of the protection effect being detectable.

These disadvantages can be circumvented or at least lessened by using the invention. The user is unambiguously identified by his presence alone (together with the identification mark characterizing him). If the user goes away from the computer, the most varied responses are conceivable: from simply blocking the workstation to the complete logging-out from the system. The strength of this method is based on its inevitability; the user can no longer forget to block his workstation as a result of which the unwanted drain of information is prevented. Unlike with a password, the identification mark can only be copied with considerable technical expenditure. The hardware keys previously normally used in software licensing have the disadvantage that they only can be used comfortably in the case of a machine-dependent license. The invention makes it possible for a user to be able to work on different (e.g. networked) computers and the software to be enabled in each case at the computer at which he happens to be located. The duration of use can be logged for each license number and a license fee dependent on the duration of use can be charged.

We claim:

1. A configuration for generating an information-bearing response signal to a received electromagnetic radiation, comprising:
a receiver for the electromagnetic radiation;
a transducer coupled to the receiver for changing the radiation into a storable secondary energy;
a storage device connected to said transducer for storing the storable secondary energy;
a nonlinear element connected to said storage device for generating a pulse-shaped radio-frequency signal from the storable secondary energy when a threshold value is reached in the storage device;
a coding element connected to said nonlinear element for impressing information on the radio-frequency signal to generate a response signal; and
a transmitting antenna connected to said coding element for broadcasting the response signal.

2. The configuration according to claim 1, wherein said transducer is a heating element and said storage device is a heat storage device.

3. The configuration according to claim 2, wherein said storage device a pyroelectrical element.

4. The configuration according to claim 1, wherein said receiver is a radio receiver.

5. The configuration according to claim 1, wherein a photoelectric element acts as said receiver and said transducer.

6. The configuration as claimed in claim 5, wherein said storage device stores electrical energy.

7. The configuration according to claim 1, wherein a photovoltaic element acts as said receiver and said transducer.

8. The configuration as claimed in claim 7, wherein said storage device stores electrical energy.

9. The configuration according to claim 1, wherein said storage device is a capacitor.

10. The configuration according to claim 1, wherein said storage device is an electrochemical storage element.

11. The configuration according to claims 1, wherein said receiver is an infrared receiver.

12. The configuration according to claim 1, wherein said nonlinear element is a spark gap.

13. The configuration according to claim 1, wherein said nonlinear element is a diode.

14. The configuration according to claim 1, wherein said nonlinear element is a gas discharge tube.

15. The configuration according to claim 1, wherein said nonlinear element is an avalanche semiconductor element.

16. The configuration according to claim 1, wherein said coding element is a SAW component.

17. The configuration according to claim 1, wherein said coding element is a resonator configuration.

18. The configuration according to claim 1, wherein said coding element is a delay line.

19. The configuration according to claim 1, wherein said coding element is a dielectric filter.

20. The configuration according to claim 1, wherein said coding element is a coaxial ceramic filter.

21. The configuration according to claim 1, wherein said coding element is a volume transducer.

22. The configuration according to claim 1, wherein said coding element is an LC filter.

23. The configuration according to claim 1, wherein said coding element is a sensor.

24. A method for remotely interrogating a configuration for generating an information-bearing response signal to a received electromagnetic radiation, which sequentially comprises:
providing a configuration;
generating an electromagnetic radiation of relatively low amplitude in an interrogating device;
transmitting the radiation to the configuration;
storing secondary energy of the radiation in the configuration;
generating a short pulse-shaped radio-frequency signal of relatively high amplitude from the stored secondary energy when a threshold value is reached;
impressing an information item on the short radio-frequency signal to generate a response signal; and
radiating the response signal.

25. The method according to claim 24, which further comprises:
storing the secondary energy as heat in a pyroelectrical element;
generating a temperature-dependent pyroelectrical voltage with the pyroelectrical element; and
generating with a nonlinear element the radio-frequency signal when a predetermined pyroelectrical voltage is reached as threshold value.

26. The method according to claim 24, wherein the information item is an identification code.

27. The method according to claim 24, which further comprises impressing the information relating to a type of an environmental parameter on the radio-frequency signal with a sensor that specifically reacts to the environmental parameter.

28. The method according to claim 24, which further comprises impressing the information relating to a quantity of an environmental parameter on the radio-frequency signal with a sensor that specifically reacts to the environmental parameter.
